(19) United States
(12) Patent Application Publication
(10) Pub. No.: US 2019/0220854 A1
(43) Pub. Date: Jul. 18, 2019

(54) Techniques for Blockchain Transactions

(71) Applicant: Spera, Inc., Cedar Hills, UT (US)

(72) Inventors: Gregori Pesci, Cedar Hills, UT (US); Joshua Warren Child, Saratoga Springs, UT (US); Damon Hogan, Orem, UT (US)

(21) Appl. No.: 16/240,650

(22) Filed: Jan. 4, 2019

Related U.S. Application Data
(60) Provisional application No. 62/618,190, filed on Jan. 17, 2018.

(51) Int. Cl. G06Q 20/38; G06Q 20/06; G06Q 20/36; H04L 9/06

(52) U.S. Cl. CPC G06Q 20/381; H04L 9/0637; G06Q 20/3678; G06Q 20/0658

(57) ABSTRACT

Techniques are described herein that allows servicers to provide services a way to easily exchange cryptocurrencies in exchange for goods or services. A transaction component may be configured to facilitate fiat currency transactions using one or more fiat currency exchanges and may be configured to facilitate cryptocurrency transactions using one or more cryptocurrency exchanges. The transaction component may be configured to exchange fiat currencies for cryptocurrencies, exchange cryptocurrencies for fiat currencies, and/or exchange a cryptocurrency for a different cryptocurrency.

### BACKGROUND

The following relates generally to cryptocurrencies and, more specifically to techniques for blockchain transactions. Cryptocurrencies represent a form of a distributed electronic monetary system. Cryptocurrencies may use cryptographic algorithms, such as a blockchain, to record transactions, control the creation of additional units, and to protect against fraud, such as double-spending. Many cryptocurrencies rely on a decentralized network of independent computers to collectively manage the currency, instead of a central governing authority. For many cryptocurrencies, every computer in the decentralized network may have a copy of the blockchain, or a ledger that records all of the transactions of the cryptocurrency. Transactions and linked to previous transactions in a manner that prevents fraudulent transfers of the cryptocurrency (e.g., double spending the same unit of cryptocurrency). For a transaction to be successful, independent computers of the decentralized network must verify the transfer.

In recent years the independent workforce has grown and will likely continue to grow in future years. Advancements in communication networks and other technologies has provided a way for people to provide services to clients from all around the globe. Cryptocurrencies may be used to transfer funds, or value, between two parties.

### SUMMARY

A method is described. The method may include receiving data indicating a request for payment from a first party to a second party, determining that a requested medium of exchange includes a cryptocurrency having a blockchain based at least in part on receiving the data, transmitting a message to the first party that includes the request for payment and the requested medium of exchange, and initiating a blockchain transaction of the blockchain of the cryptocurrency to update a ledger of the blockchain based at least in part on transmitting the message to the first party that includes the request for payment and the requested medium of exchange.

An apparatus is described. The apparatus may include means for receiving data indicating a request for payment from a first party to a second party, means for determining that a requested medium of exchange includes a cryptocurrency having a blockchain based at least in part on receiving the data, means for transmitting a message to the first party that includes the request for payment and the requested medium of exchange, and means for initiating a blockchain transaction of the blockchain of the cryptocurrency to update a ledger of the blockchain based at least in part on transmitting the message to the first party that includes the request for payment and the requested medium of exchange.

Another apparatus is described. The apparatus may include a processor, memory in electronic communication with the processor, and instructions stored in the memory. The instructions may be operable to cause the processor to receive data indicating a request for payment from a first party to a second party, determine that a requested medium of exchange includes a cryptocurrency having a blockchain based at least in part on receiving the data, transmit a message to the first party that includes the request for payment and the requested medium of exchange, and initiate a blockchain transaction of the blockchain of the cryptocurrency to update a ledger of the blockchain based at least in part on transmitting the message to the first party that includes the request for payment and the requested medium of exchange.

A non-transitory computer-readable medium is described. The non-transitory computer-readable medium may include instructions operable to cause a processor to receive data indicating a request for payment from a first party to a second party, determine that a requested medium of exchange includes a cryptocurrency having a blockchain based at least in part on receiving the data, transmit a message to the first party that includes the request for payment and the requested medium of exchange, and initiate a blockchain transaction of the blockchain of the cryptocurrency to update a ledger of the blockchain based at least in part on transmitting the message to the first party that includes the request for payment and the requested medium of exchange.

Some examples of the method, apparatus, and non-transitory computer-readable medium described above may further include processes, features, means, or instructions for receiving fiat currency from the first party in response to transmitting the message, wherein initiating the blockchain transaction may be based at least in part on receiving the fiat currency.

Some examples of the method, apparatus, and non-transitory computer-readable medium described above may further include processes, features, means, or instructions for determining that the fiat currency received from the first party may be not included in the requested medium of exchange of the message, wherein initiating the blockchain transaction may be based at least in part on determining that the fiat currency received from the first party may be not included in the requested medium of exchange of the message.

Some examples of the method, apparatus, and non-transitory computer-readable medium described above may further include processes, features, means, or instructions for assigning a transaction identifier to the blockchain transaction before initiating the blockchain transaction.

Some examples of the method, apparatus, and non-transitory computer-readable medium described above may further include processes, features, means, or instructions for identifying a user identifier associated with the cryptocurrency. Some examples of the method, apparatus, and non-transitory computer-readable medium described above may further include processes, features, means, or instructions for generating combined identifier by combining the user identifier and the transaction identifier, wherein the blockchain transaction may be initiated using the combined identifier.

Some examples of the method, apparatus, and non-transitory computer-readable medium described above may further include processes, features, means, or instructions for identifying a plurality of exchanges associated with the cryptocurrency. Some examples of the method, apparatus, and non-transitory computer-readable medium described above may further include processes, features, means, or instructions for selecting one exchange of the plurality of exchanges to initiate the blockchain transaction, wherein initiating the blockchain transaction may be based at least in part on selecting the one exchange.

Some examples of the method, apparatus, and non-transitory computer-readable medium described above may further include processes, features, means, or instructions for comparing the request for payment and the requested medium of exchange to a pool balance associated with the requested medium of exchange. Some examples of the method, apparatus, and non-transitory computer-readable medium described above may further include processes, features, means, or instructions for transmitting, to the second party, at least a portion of the request for payment in the cryptocurrency taken from the pool balance based at least in part on initiating the blockchain transaction.

Some examples of the method, apparatus, and non-transitory computer-readable medium described above may further include processes, features, means, or instructions for receiving an acknowledgement that the blockchain transaction may be successful. Some examples of the method, apparatus, and non-transitory computer-readable medium described above may further include processes, features, means, or instructions for transmitting, to the second party, at least a portion of the request for payment in the cryptocurrency based at least in part on receiving the acknowledgement.

Some examples of the method, apparatus, and non-transitory computer-readable medium described above may further include processes, features, means, or instructions for transmitting a notification to the first party that the second party may have received the cryptocurrency as part of the request for payment.

Some examples of the method, apparatus, and non-transitory computer-readable medium described above may further include processes, features, means, or instructions for receiving a second cryptocurrency from the first party in response to transmitting the message, wherein initiating the blockchain transaction may be based at least in part on receiving the second cryptocurrency.

Some examples of the method, apparatus, and non-transitory computer-readable medium described above may further include processes, features, means, or instructions for determining that the second cryptocurrency received from the first party may be not included in the requested medium of exchange of the message, wherein initiating the blockchain transaction may be based at least in part on determining that the second cryptocurrency received from the first party may be not included in the requested medium of exchange of the message.

Some examples of the method, apparatus, and non-transitory computer-readable medium described above may further include processes, features, means, or instructions for initiating a second blockchain transaction for the second cryptocurrency to exchange the second cryptocurrency for the cryptocurrency included in the requested medium of exchange.

Some examples of the method, apparatus, and non-transitory computer-readable medium described above may further include processes, features, means, or instructions for encrypting data related to the blockchain transaction before initiating the blockchain transaction.

A method is described. The method may include receiving data indicating a request for payment from a first party to a second party, transmitting a first message to the first party that includes the request for payment, receiving fiat currency from the first party in response to transmitting the message, wherein initiating the blockchain transaction is based at least in part on receiving the fiat currency, receiving a second message from the second party indicating a requested medium of exchange based at least in part on receiving the fiat currency, and initiating a blockchain transaction of a blockchain of the cryptocurrency to update a ledger of the blockchain based at least in part on receiving the fiat currency and the second message.

An apparatus is described. The apparatus may include means for receiving data indicating a request for payment from a first party to a second party, means for transmitting a first message to the first party that includes the request for payment, means for receiving fiat currency from the first party in response to transmitting the message, wherein initiating the blockchain transaction is based at least in part on receiving the fiat currency, means for receiving a second message from the second party indicating a requested medium of exchange based at least in part on receiving the fiat currency, and means for initiating a blockchain transaction of a blockchain of the cryptocurrency to update a ledger of the blockchain based at least in part on receiving the fiat currency and the second message.

Another apparatus is described. The apparatus may include a processor, memory in electronic communication with the processor, and instructions stored in the memory. The instructions may be operable to cause the processor to receive data indicating a request for payment from a first party to a second party, transmit a first message to the first party that includes the request for payment, receive fiat currency from the first party in response to transmitting the message, wherein initiating the blockchain transaction is based at least in part on receiving the fiat currency, receive a second message from the second party indicating a requested medium of exchange based at least in part on receiving the fiat currency, and initiate a blockchain transaction of a blockchain of the cryptocurrency to update a ledger of the blockchain based at least in part on receiving the fiat currency and the second message.

A non-transitory computer-readable medium is described. The non-transitory computer-readable medium may include instructions operable to cause a processor to receive data indicating a request for payment from a first party to a second party, transmit a first message to the first party that includes the request for payment, receive fiat currency from the first party in response to transmitting the message, wherein initiating the blockchain transaction is based at least in part on receiving the fiat currency, receive a second message from the second party indicating a requested medium of exchange based at least in part on receiving the fiat currency, and initiate a blockchain transaction of a blockchain of the cryptocurrency to update a ledger of the blockchain based at least in part on receiving the fiat currency and the second message.

Some examples of the method, apparatus, and non-transitory computer-readable medium described above may further include processes, features, means, or instructions for determining the requested medium of exchange based at least in part on receiving the second message, wherein initiating the blockchain transaction may be based at least in part on determining the requested medium of exchange.

A method is described. The method may include receiving data indicating a request for payment from a first party to a second party, transmitting a first message to the first party that includes the request for payment, receiving a second message from the first party indicating a cryptocurrency transaction based at least in part on transmitting the first message, and initiating a blockchain transaction of a blockchain of the cryptocurrency to update a ledger of the blockchain based at least in part on receiving the second message.

An apparatus is described. The apparatus may include means for receiving data indicating a request for payment from a first party to a second party, means for transmitting a first message to the first party that includes the request for payment, means for receiving a second message from the first party indicating a cryptocurrency transaction based at least in part on transmitting the first message, and means for initiating a blockchain transaction of a blockchain of the cryptocurrency to update a ledger of the blockchain based at least in part on receiving the second message.

Another apparatus is described. The apparatus may include a processor, memory in electronic communication with the processor, and instructions stored in the memory. The instructions may be operable to cause the processor to receive data indicating a request for payment from a first party to a second party, transmit a first message to the first party that includes the request for payment, receive a second message from the first party indicating a cryptocurrency transaction based at least in part on transmitting the first message, and initiate a blockchain transaction of a blockchain of the cryptocurrency to update a ledger of the blockchain based at least in part on receiving the second message.

A non-transitory computer-readable medium is described. The non-transitory computer-readable medium may include instructions operable to cause a processor to receive data indicating a request for payment from a first party to a second party, transmit a first message to the first party that includes the request for payment, receive a second message from the first party indicating a cryptocurrency transaction based at least in part on transmitting the first message, and initiate a blockchain transaction of a blockchain of the cryptocurrency to update a ledger of the blockchain based at least in part on receiving the second message.

Some examples of the method, apparatus, and non-transitory computer-readable medium described above may further include processes, features, means, or instructions for determining that a requested medium of exchange includes the cryptocurrency. Some examples of the method, apparatus, and non-transitory computer-readable medium described above may further include processes, features, means, or instructions for transferring the cryptocurrency to the second party based at least in part on determining the requested medium of exchange includes the cryptocurrency.

Some examples of the method, apparatus, and non-transitory computer-readable medium described above may further include processes, features, means, or instructions for determining that a requested medium of exchange includes a cryptocurrency having a second block different than the cryptocurrency and the blockchain. Some examples of the method, apparatus, and non-transitory computer-readable medium described above may further include processes, features, means, or instructions for initiating a second blockchain transaction of the second blockchain of the second cryptocurrency based at least in part on determining the requested medium of exchange includes the second cryptocurrency. Some examples of the method, apparatus, and non-transitory computer-readable medium described above may further include processes, features, means, or instructions for initiating a third blockchain transaction of the blockchain of the cryptocurrency based at least in part on determining the requested medium of exchange includes the second cryptocurrency.

Some examples of the method, apparatus, and non-transitory computer-readable medium described above may further include processes, features, means, or instructions for determining that a requested medium of exchange includes a fiat currency. Some examples of the method, apparatus, and non-transitory computer-readable medium described above may further include processes, features, means, or instructions for initiating a second blockchain transaction of the blockchain of the cryptocurrency based at least in part on determining the requested medium of exchange includes the fiat currency.

### BRIEF DESCRIPTION OF THE DRAWINGS

FIG. 1 illustrates an example of a system that supports techniques for blockchain transactions in accordance with aspects of the present disclosure.

FIG. 2 illustrates an example of a computing environment that supports techniques for blockchain transactions in accordance with aspects of the present disclosure.

FIG. 3 illustrates an example of a system architecture of a transaction component that supports techniques for blockchain transactions in accordance with aspects of the present disclosure.

FIG. 4 shows a block diagram of a device that supports techniques for blockchain transactions in accordance with aspects of the present disclosure.

FIGS. 5 through 7 illustrate methods for techniques for blockchain transactions in accordance with aspects of the present disclosure.

### DETAILED DESCRIPTION

In recent years, the number of independent contractors active in the workforce has increased. Advances in technology has provided a way to for people to operate independently of other business structures. In addition, advances in technology has allowed people to provide goods and services to clients and customers all over the globe. One challenge that faces independent contractors is getting paid in a prompt manner. Geography, governments, and currencies may pose impediments to getting paid quickly when working in a global environment.

Techniques are provided herein for a transaction component that allows independent contractors to get paid in the cryptocurrency of their choice. The techniques described herein may provide cryptocurrency transactions to users without users having to sign up for one or more cryptocurrency exchanges. In addition, the techniques may allow users to pay using a fiat currency but the independent contractor still receive a cryptocurrency. In this way, the parties involved in the transaction can independently operate in a currency with which they are comfortable. In some cases, the techniques described herein may aggregate cryptocurrencies across a plurality of cryptocurrency exchanges.

Aspects of the disclosure are described in the context of a system and a transaction component. Aspects of the disclosure are further illustrated by and described with reference to an apparatus diagram and flowcharts that relate to techniques for blockchain transactions.

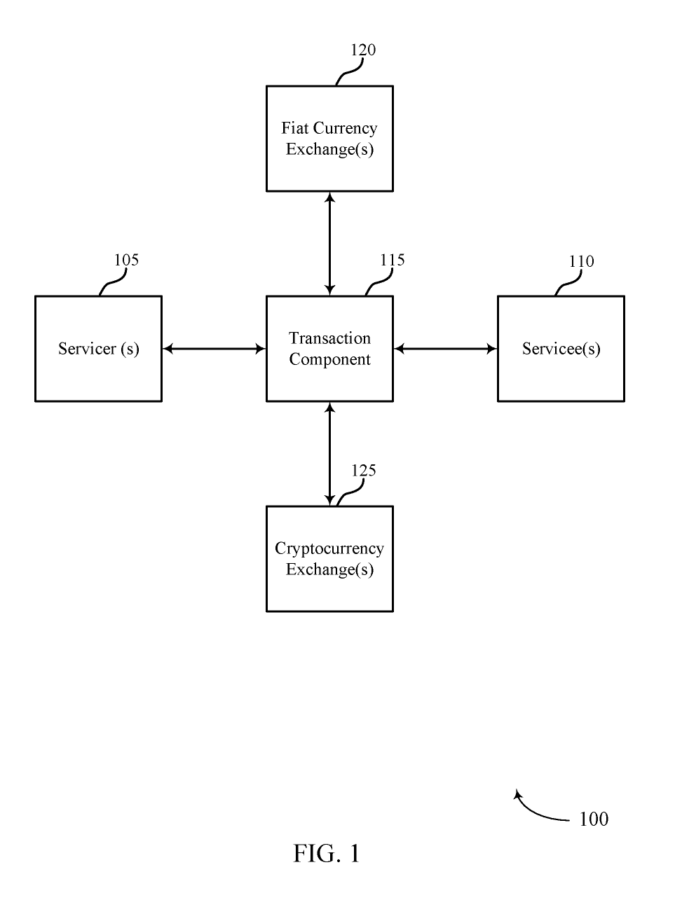

FIG. 1 illustrates an example of a digital office system 100 that supports techniques for blockchain transactions in accordance with various aspects of the present disclosure. The digital office system 100 may be configured to help one or more servicer(s) 105 to manage work provided to one or more servicee(s) 110. A servicer 105 may be example of an independent contractor, a freelancer, or a small business owner that provides goods and/or service to one or more servicees 110. In some cases, the servicer 105 may provide goods and services to the servicee 110 in exchange for money or some other value. One challenge faced by servicers 105 is getting paid by servicees 110 in a prompt manner.

Cryptocurrencies present an option for paying servicers 105 for their services. For example, cryptocurrencies may be used as an easy and inexpensive way to pay servicers 105 that are located in different countries than the servicees 110. If a servicer 105 or other party wishes to be get paid in a cryptocurrency, the servicer 105 or other party may sign up for one or more exchanges, digital wallets, or dashboards that allow users to buy and sell cryptocurrencies. In addition, the servicee 110 may also signup for the same exchange, digital wallet, or dashboard as the servicer 105 to exchange cryptocurrencies. Many of the existing exchanges of cryptocurrencies are difficult to sign up for and are difficult to use. Such difficulties in user experiences has prevented some people from using cryptocurrencies as a medium of exchange to pay for goods and/or services.

Techniques are described herein that allows servicers 105 to provide servicees 110 a way to easily exchange cryptocurrencies in exchange for goods or services. A transaction component 115 may be configured to facilitate fiat currency transactions using one or more fiat currency exchange(s) 120 and may be configured to facilitate cryptocurrency transactions using one or more cryptocurrency exchange(s) 125. The transaction component 115 may be configured to exchange fiat currencies for cryptocurrencies, exchange cryptocurrencies for fiat currencies, and/or exchange a cryptocurrency for a different cryptocurrency.

The transaction component 115 also may be configured to organize work flows of the servicer 105, organize and prioritize to-do items, manage invoices, and receive and/or make payments. The transaction component 115 may be configured to facilitate fiat currency exchanges and cryptocurrency exchanges as part of the receiving and/or making payments. The transaction component 115 may be an application configured to be executed or run by one or more devices (e.g., personal computing devices and/or core entities). The transaction component 115 may include one or more application programming interfaces (APIs) for interacting with other programs. For example, the transaction component 115 may include a cryptocurrency API for communicating with a cryptocurrency exchange 125 and/or an algorithm (e.g., blockchain) of a cryptocurrency directly.

A fiat currency may be an example of currency that a government has declared to be legal tender. In some cases, a fiat currency may be not backed by a physical commodity. Examples of fiat currencies may include the United States dollar, the Euro, the British pound, the Japanese Yen, the Swiss franc, the Canadian dollar, the South Korean won, the Chinese Renminbi, and others.

A fiat currency exchange 120 may be an process or entity used to exchange fiat currency for goods or services. Examples of fiat currency exchanges 120 may include credit card payments, automated clearing house payments, wire transfers, propay systems, debit card transactions, or other forms of processing payments.

A cryptocurrency may be an example of a medium of exchange that is not backed by a central authority, such as a government. A cryptocurrency may be a digital asset that may use cryptography to record transactions, control the creation of additional units, and to protect against fraud (e.g., double spending). In some cases, a cryptocurrency may be controlled by a decentralized network of peer computers. The cryptographic algorithms of the cryptocurrency may rely on distributed ledgers (such as a blockchain) to record transactions and to prevent fraud. To maintain the integrity of the cryptocurrency and/or to prevent fraud such as double spending of a single unit, the cryptographic algorithms may rely on a plurality of independent computers to validate and record transactions on the ledger (e.g., a blockchain). In theory, the self-interest of each of the independent computers (sometimes referred to as miners) maintain the security of the ledger. Examples of cryptocurrencies include Bitcoin, Ethereum, Ripple, Litecoin, Dash, NEM, Ethereum Classic, Monero, Zcash, Decred, PIVX, Bitcoin Cash, Cardano, NEO, Stellar, IOTA, EOS, TRON, Bitcoin Gold, Qtum, ICON, Lisk, RaiBlocks, Ardor, OmiseGo, other altcoin, or a combination thereof.

A cryptocurrency exchange 125 may be a process or an entity used to exchange cryptocurrency for goods and/or services, other cryptocurrencies, and/or fiat currency. Cryptocurrency exchanges may be configured as trading platforms, direct trading, brokers, or a combination thereof. Trading platforms may be exchanges that connect buyers and sellers and take a fee from each transaction. Direct trading platforms may offer direct person-to-person trading where each seller sets their own fees and/or rates for an exchange. Brokers may be platforms that can purchase or sell a cryptocurrency at a price set by the broker. Examples of cryptocurrency exchanges 125 may include Coinbase, Kraken, Cex.io, ShapeShift, Poloniex, Bitstamp, CoinMama, Bitsquare, Gemini, other exchange, or a combination thereof.

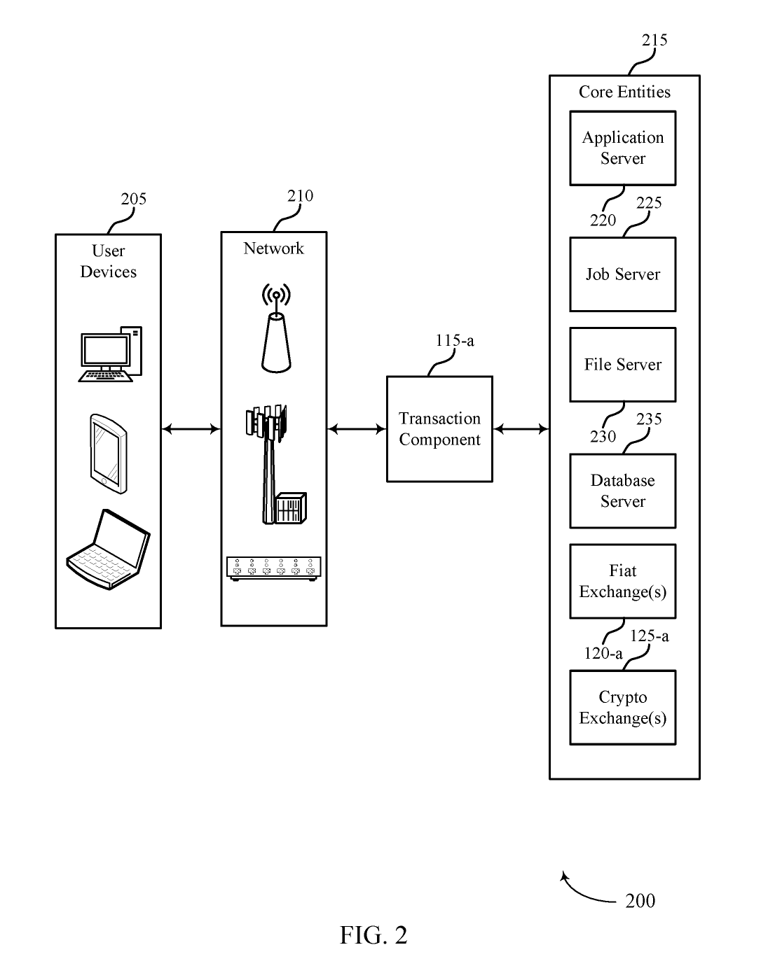

FIG. 2 illustrates an example of a computing environment 200 that supports techniques for blockchain transactions in accordance with various aspects of the present disclosure. The computing environment 200 may show how the transaction component 115-a interacts with one or more user devices 205, one or more networks 210, and/or one or more core entities 215. Portions of the transaction component 115-a may be located on the user devices 205 and/or the core entities 215.

The servicers 105, servicees 110, and/or other users of the transaction component 115-a may be configured to access the transaction component 115-a using one or more electronic devices. The user devices 205 may be dispersed throughout the wireless communications system, and each user device 205 may be stationary or mobile. Examples of user devices may include a cellular phone, a smartphone, a personal digital assistant (PDA), a tablet computer, a laptop computer, a personal computer, or some combination thereof. Other examples of user devices 205 may include an Internet of Things (IoT) device, which may be implemented in various articles such as appliances, vehicles, meters, or the like.

In some cases, the user device 205 may access the transaction component 115-a using an application associated with the transaction component 115-a. For example, the transaction component 115-a may be an application or program installed on a user device 205 that provides a portal for the user (e.g., servicer 105 or servicee 110) to access the functionality of the transaction component 115-a described herein.

The user devices 205 may communicate with the transaction component 115-a or the core entities 215 that comprise the transaction component 115-a using one or more networks. The network 210 may include wired communication links, wireless communication links, or a combination thereof. The network 210 may be the Internet, an intranet, a personal area network, a local area network (LAN), a wide area network (WAN), a virtual network, a telecommunications network implemented as a wired network and/or wireless network, etc. Examples of wireless networks may include Wi-Fi networks (e.g., networks that use the Institute of Electrical and Electronics Engineers (IEEE) 802.11 family of standards) and/or cellular networks (e.g., using 3G, CDMA, LTE, or 5G). The networks may be accessed using one or more access devices that may include access points, routers, base stations, modems, other types of devices, or a combination thereof.

In some cases, the transaction component 115-a may comprise one or more applications, processes, and/or programs being performed by one or more core entities 215. Core entities 215 may include any servers, databases, and/or cloud-based computing solutions used to implement the functions of the transaction component 115-a. Core entities 215 may also include external servers, databases, and/or cloud-based computing solutions accessed or communicated with by the transaction component. The core entities 215 may include one or more application server(s) 220, one or more job server(s) 225, one or more file server(s) 230, one or more database server(s) 235, one or more fiat currency exchanges 120-a, one or more cryptocurrency exchanges 125-a, other servers, other databases, other cloud-based computing solutions, or various combinations thereof.

The one or more application servers 220 may be configured to implement technology associated with a web interface. The one or more application servers 220 may utilize a Linux, Apache, MySQL, and PHP/Python/Perl (LAMP) stack configured to allow users to interact with the transaction component 115-a and/or initiate functions of the transaction component 115-a including performing fiat currency transactions, cryptocurrency transactions, fiat-to-fiat currency transactions, fiat-to-crypto currency transactions, crypto-to-fiat currency transactions, crypto-to-crypto transactions, or a combination thereof. The one or more application servers 220 may also be configured to manage user profiles and accounts and other data organization functions.

The one or more job servers 225 may be configured to process computing jobs on a timed schedule. The one or more job servers 225 may be configured to process recurring payments. The one or more job servers 225 may be configured to perform maintenance of one or more of the core entities 215.

The one or more file servers 230 may be configured to process images, backup files and other data, and process/manage other files and/or programs with the one or more application servers 220. The one or more file servers 230 may be an example of a S3 bucket.

The one or more database servers 235 may be configured to store APIs, tokens, and/or credentials associated with the transaction component 115-a and/or with users of the transaction component 115-a (e.g., servicers 105 and/or servicees 110). The APIs, tokens and/or credentials may be configured to perform transactions involving one or more cryptocurrencies, one or more fiat currencies, or a combination thereof. The one or more database servers 235 may an example of a relational database service (RDS).

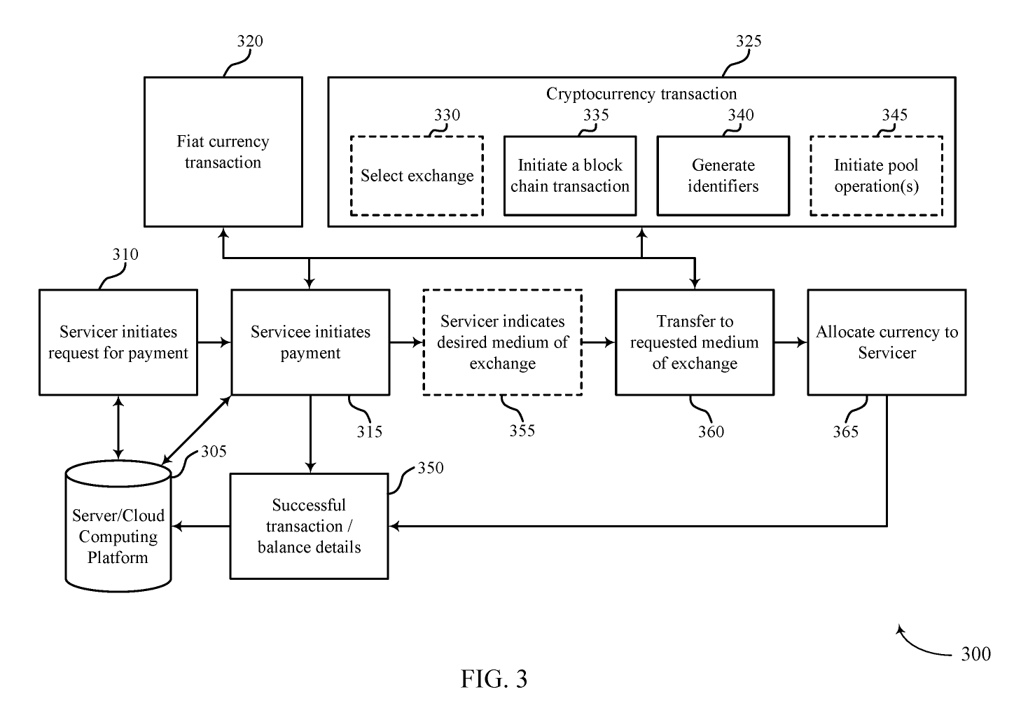

FIG. 3 illustrates an example of a system architecture 300 of a transaction component 115 that supports techniques for blockchain transactions in accordance with various aspects of the present disclosure. The system architecture 300 shows examples of functions and/or communications performed by the transaction component 115. The system architecture 300 includes a server/cloud computing platform 305. The server/cloud computing platform 305 may be configured to coordinate the various functions (e.g., currency transactions, workflow management, etc.) and various communications performed by the transaction component, including the functions and communications originating from user devices 205 and/or core entities 215.

The server/cloud computing platform 305 may be configured to manager profiles of users and other account information. Before using the transaction component 115 to initiate currency transactions and/or payments, the transaction component 115 may track jobs completed, services performed, goods sold, or other features associated with the servicer 105.

At block 310, the servicer 105 may initiate a request for payment from a servicee 110 to the servicer for goods and/or services rendered. In some cases, the request for payment may be an example of an invoice. The invoice may list the goods and/or services rendered and an amount of payment requested for those goods and services. The servicer 105 may generate the invoice using a portion of the transaction component 115 being executed on a user device 205 (e.g., an application or a program).

In some cases, the invoice may include a requested medium of exchange. For example, the servicer 105 may request that the servicer 105 receive payment in a specific cryptocurrency or in a specific fiat currency. The transaction component 115 may determine that the requested medium of exchange includes a cryptocurrency having a blockchain.

In some cases, the requested medium of exchange is shared with the servicee 110, thereby allowing the servicee 110 the opportunity to pay in the medium of exchange requested by the servicer 105. In other cases, however, the requested medium of exchange may not be shared with the servicee 110. In such cases, the transaction component 115 may be configured to accept payment from the servicee 110 in any medium of exchange and convert the servicee's medium of exchange for the medium of exchange requested by the servicer 105. Such a functionality may allow for the prompt payment of servicers 105 without the servicee 110 having to transact business in unfamiliar mediums of exchange.

The server/cloud computing platform 305 may receive the data associated with the request for payment. The server/cloud computing platform 305 may generate a message to the servicee 110 that includes the request for payment (e.g., the invoice). The message may be transmitted to an instance of the transaction component 115 being executed by a user device 205 associated with the servicee 110. In some cases, the request for payment may be communicated to the servicee 110 using email, messaging, or some other communication service outside of the transaction component 115.

At block 315, the servicee 110 (or a computing device associated with the servicee 110) may initiate payment of the invoice. In some cases, the payment may be processed by the transaction component 115. The servicee 110 may be allowed to pay using either a fiat currency or a cryptocurrency. In some cases, the servicee 110 may be allowed to choose which type of currency will be used to pay the invoice. In some cases, the servicee 110 may be requested and/or required to pay using the medium of exchange requested by the servicer 105 in the invoice.

If the servicee 110 pays the invoice using a fiat currency, the transaction component may initiate a fiat currency transaction at block 320. The fiat currency transaction may involve transferring a fiat currency from an account associated with the servicee 110 to an account associated with the transaction component 115. In some cases, the transaction component 115 may include a fiat currency account for each user that may have a balance. In other cases, the transaction component 115 may be configured to process payments on a transaction-by-transaction basis. The servicee 110 may either transfer money from the associated account balance in the transaction component ecosystem or the servicee 110 may transfer money from an external account. Examples of a fiat currency transaction may include a ACH, a credit card payment, a debit card payment, a wire transfer, a cashier's check, an electronic funds transfer, a propay payment, or a combination thereof.

If the servicee 110 pays the invoice using a cryptocurrency, the transaction component 115 may initiate a cryptocurrency transaction at block 325. The cryptocurrency transaction may involve transferring a cryptocurrency from an external account to an account associated with the transaction component 115. The cryptocurrency transaction may also involve transferring a cryptocurrency from an account of the servicee 110 associated with the transaction component 115 with another account associated with the transaction component. The cryptocurrency transaction may also involve, in some cases, using a fiat currency to purchase a cryptocurrency. As part of a cryptocurrency transaction, the servicee 110 may either transfer money from the associated account balance in the transaction component ecosystem or the servicee 110 may transfer money from an external account.

In some instances, the servicee 110 may elect to pay with cryptocurrency already in the servicee's possession and may not use the transaction component 115 to purchase additional cryptocurrency using fiat currency. In such cases, the transaction component 115 may identify the cryptocurrency being transferred by the servicee 110. In some examples, the transaction component 115 may be coupled with one or more cryptocurrency exchanges. In such cases, the transaction component 115 may select which cryptocurrency exchange to use based on the selected cryptocurrency before performing the cryptocurrency transaction at block 330. In some cases, the servicee 110 may indicate which exchange the transaction component 115 is to use. To transfer the cryptocurrency funds from the servicee 110 to an account associated with the transaction component 115, the transaction component 115 may initiate a blockchain transaction on a blockchain (e.g., ledger) associated with the selected cryptocurrency at block 335.

In some cases, the cryptocurrency transaction may use an account at a cryptocurrency exchange associated with the transaction component 115 to perform the block chain transaction. The transaction component 115 may generate one or more identifier(s) as part of the cryptocurrency exchange at block 340. The transaction component 115 may generate a user-specific identifier, a transaction component identifier, a transaction identifier, or various combinations thereof. For example, the transaction component 115 may be registered as a user of a particular cryptocurrency exchange. As such, the transaction component 115 may have a unique identifier with the cryptocurrency exchange and/or a private key/public key pair for encrypting data shared with cryptocurrency exchange. To track the various transactions between users in the ecosystem of the transaction component 115. The transaction component 115 may generate a transaction-specific identifier and/or a user-specific identifier to use during the blockchain transaction. In some cases, the transaction component 115 may generate a combined identifier that includes the identifier of the transaction component 115 and one or more identifiers associated with the user and/or the specific transaction.

In some cases, the transaction component 115 may have pools or trust accounts in each of the different cryptocurrencies. Instead of transferring a cryptocurrency directly between users, the transaction component 115 may transfer the cryptocurrency to or from a pool account associated with the transaction component 115 at block 345. In such cases, the transaction component 115 may be configured to act as a clearinghouse for various transactions. In such cases, the transaction component 115 may check a balance of a pool associated with the currency in question and may transfer funds to or from the pool rather than initiate a blockchain transaction immediately. In such situations, the transaction component 115 may complete the blockchain transaction later, but the parties involved may gain access to their funds before such a blockchain transaction is complete.

In some cases, the transaction component 115 may perform blockchain transactions and may not use a cryptocurrency exchange. In such situations, the transaction component 115 may be configured to directly record a transaction on the blockchain and perform the necessary calculations and processes. In such cases, the transaction component 115 may include additional components and/or may be coupled with computing device(s) that may act a cryptocurrency miner.

To exchange cryptocurrencies, the transaction component 115 may also be configured to encrypt data related to the blockchain transaction before initiating the blockchain transaction. Conversely, in some cases, the transaction component 115 may be configured to decrypt data related to the blockchain transaction. Cryptocurrencies may include some type of encryption (e.g., public key/private key encryption) to protect data and user's identities. The transaction component 115 may be configured to operate within the encryption parameters of the cryptocurrency.

In some cases, the server/cloud computing platform 305 may receive a message indicating that the servicee 110 has made the payment (or a partial payment as the case may be). The server/cloud computing platform 305 may transmit a message to the servicer 105 indicating the payment. For example, at block 350, the transaction component 115 may be configured to notify the servicer 105 and/or the servicee 110 that a transaction was successful (or not successful as the case may be) and/or balance details related to the user and/or the transaction.

In some instances, the transaction component 115 may query the servicer 105 to determine the medium of exchange that the servicer 105 would like to receive. In such instances, the medium of exchange paid by the servicee 110 and the medium of exchange received by the servicer 105 may be independent of one another. Meaning that the actions/choices of the servicer 105 may impact or influence the actions/choices of the servicee 110 regarding payment. In some cases, at block 355, the transaction component 115 may receive a message indicating the requested medium of exchange of the servicer 105 based on receiving a message that the servicee 110 has paid. The transaction component 115 may be configured to determine the medium of exchange based on the information received from the servicer 105. In some cases, the information about the desired medium of exchange may be preconfigured in the servicer's profile with the transaction component, or the information about the desired medium of exchange may be communicated on a transaction-by-transaction basis, or some combination thereof.

At block 360, the transaction component 115 may be configured to transfer the funds paid by the servicee 110 to the medium of exchange requested by the servicer 105. In this manner, both the servicee 110 and the servicer 105 can pay and receive compensation using mediums of exchange that are convenient for them.

The transfer of funds between mediums of exchange may take on several different permutations. For example, if the servicee 110 pays with a fiat currency and the servicer 105 wants a cryptocurrency, the transfer may include fiat-to-crypto exchange where cryptocurrency is purchased using fiat currency. In such examples, the transaction component may initiate a cryptocurrency transaction at block 325 to purchase the cryptocurrency. The transaction component 115 may select exchanges, generate one or more identifiers, and/or initiate a blockchain transaction to purchase the cryptocurrency. The transaction component 115 may also use pool funds to pay the servicer 105. For example, if the transaction component 115 has a balance of the cryptocurrency, the transaction component 115 may transfer some of that pooled balance to the servicer 105 while the transaction component is waiting for the cryptocurrency transaction to complete. It may take several days for a blockchain transaction to complete. In this manner, the servicer 105 may gain access to funds more promptly.

In some examples, if the servicee 110 pays with a cryptocurrency and the servicer 105 requests the same cryptocurrency, the transfer may include transferring the cryptocurrencies in a crypto-to-crypto exchange using a single blockchain transaction. In some cases, the transaction component 115 may be configured to use pool resources to make this transfer if resources are available in pool resources and in an account of the servicee 110 visible to the transaction component.

In some examples, if the servicee 110 pays with a cryptocurrency and the servicer 105 requests a different cryptocurrency, the transfer may include transferring the funds in a crypto-to-crypto exchange using at least two blockchain transactions. A first blockchain transaction may be initiated for the first cryptocurrency and a second blockchain transaction may be initiated for the second cryptocurrency to make such an exchange occur. To do this, the transaction component 115 may initiate the cryptocurrency transaction at block 325 and use the procedures discussed therein.

In some examples, if the servicee 110 pays with a cryptocurrency and the servicer 105 requests a fiat currency, the transfer may include transferring the funds in a crypto-to-fiat exchange. In such examples, the transaction component may initiate a cryptocurrency transaction at block 325 to sell the cryptocurrency. The transaction component 115 may select exchanges, generate one or more identifiers, and/or initiate a blockchain transaction to sell the cryptocurrency. The transaction component 115 may also initiate a fiat currency transaction at block 320 to transfer the fiat currency funds to the servicer 105.

At block 360, the transaction component 115 may allocate the currency (whether a cryptocurrency or a fiat currency) to the servicer 105. As part of this, the transaction component 115 may determine that the funds received from the servicee 110 use a different medium of exchange than the funds requested by the servicer 105. In some cases, this allocation of funds may be done to an account associated with the transaction component 115. In some cases, this allocation of funds may be done to an account external to the transaction component 115. The transaction component 115 may be configured to, at block 350, notify the servicer 105 and/or the servicee 110 that a transaction was successful (or not successful as the case may be) and/or balance details related to the user and/or the transaction.

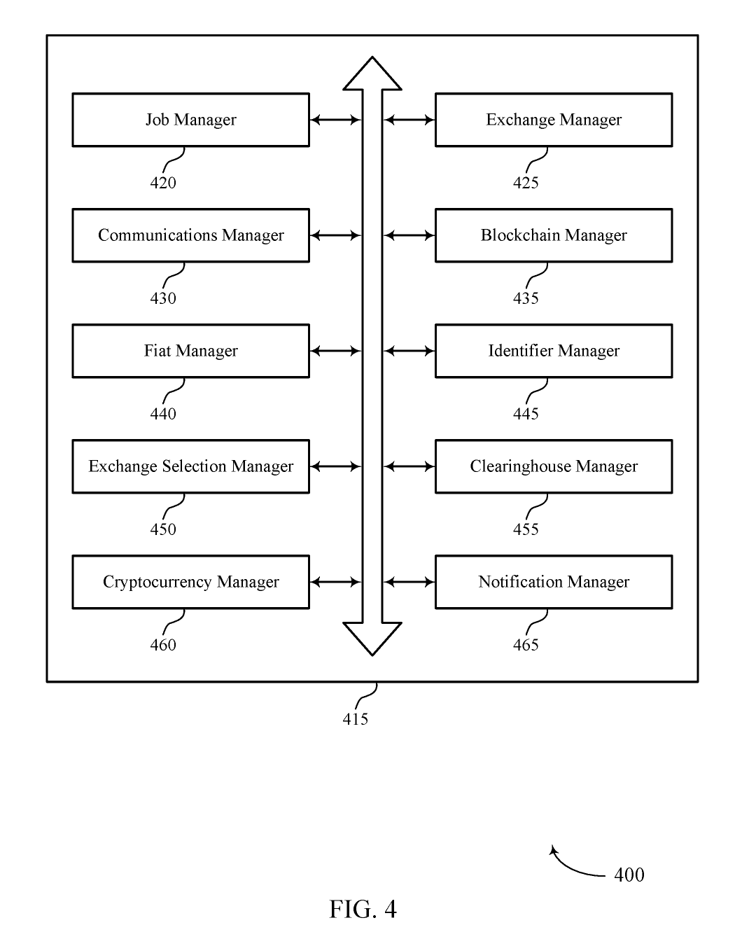

FIG. 4 shows a block diagram 400 of a transaction component 415 that supports techniques for blockchain transactions in accordance with aspects of the present disclosure. The transaction component 415 may be an example of aspects of a transaction component 115 described with reference to FIGS. 1-3. The transaction component 415 may include job manager 420, exchange manager 425, communications manager 430, blockchain manager 435, fiat manager 440, identifier manager 445, exchange selection manager 450, clearinghouse manager 455, cryptocurrency manager 460, and notification manager 465. Each of these modules may communicate, directly or indirectly, with one another (e.g., via one or more buses).

Job manager 420 may receive data indicating a request for payment from a first party to a second party.

The exchange manager 425 may determine that a requested medium of exchange includes a cryptocurrency having a blockchain based on receiving the data. The exchange manager 425 may determine that a requested medium of exchange includes the cryptocurrency. The exchange manager 425 may determine that a requested medium of exchange includes a cryptocurrency having a second block different than the cryptocurrency and the blockchain. The exchange manager 425 may determine that a requested medium of exchange includes a fiat currency. The exchange manager 425 may determine the requested medium of exchange based on receiving the second message, where initiating the blockchain transaction is based on determining the requested medium of exchange.

The communications manager 430 may transmit a message to the first party that includes the request for payment and the requested medium of exchange. The communications manager 430 may transmit a first message to the first party that includes the request for payment. The communications manager 430 may receive a second message from the second party indicating a requested medium of exchange based on receiving the fiat currency. The communications manager 430 may receive a second message from the first party indicating a cryptocurrency transaction based on transmitting the first message.

The blockchain manager 435 may initiate a blockchain transaction of the blockchain of the cryptocurrency to update a ledger of the blockchain based on transmitting the message to the first party that includes the request for payment and the requested medium of exchange. The blockchain manager 435 may initiate a second blockchain transaction for the second cryptocurrency to exchange the second cryptocurrency for the cryptocurrency included in the requested medium of exchange. The blockchain manager 435 may initiate a blockchain transaction of a blockchain of the cryptocurrency to update a ledger of the blockchain based on receiving the fiat currency and the second message. The blockchain manager 435 may initiate a blockchain transaction of a blockchain of the cryptocurrency to update a ledger of the blockchain based on receiving the second message. The blockchain manager 435 may initiate a second blockchain transaction of the second blockchain of the second cryptocurrency based on determining the requested medium of exchange includes the second cryptocurrency. The blockchain manager 435 may initiate a third blockchain transaction of the blockchain of the cryptocurrency based on determining the requested medium of exchange includes the second cryptocurrency. The blockchain manager 435 may initiate a second blockchain transaction of the blockchain of the cryptocurrency based on determining the requested medium of exchange includes the fiat currency.

The fiat manager 440 may receive fiat currency from the first party in response to transmitting the message, where initiating the blockchain transaction is based on receiving the fiat currency and determine that the fiat currency received from the first party is not included in the requested medium of exchange of the message, where initiating the blockchain transaction is based on determining that the fiat currency received from the first party is not included in the requested medium of exchange of the message.

The identifier manager 445 may assign a transaction identifier to the blockchain transaction before initiating the blockchain transaction. The identifier manager 445 may identify a user identifier associated with the cryptocurrency. The identifier manager 445 may generate combined identifier by combining the user identifier and the transaction identifier, where the blockchain transaction is initiated using the combined identifier.

The exchange selection manager 450 may identify a set of exchanges associated with the cryptocurrency and select one exchange of the set of exchanges to initiate the blockchain transaction, where initiating the blockchain transaction is based on selecting the one exchange.

The clearinghouse manager 455 may compare the request for payment and the requested medium of exchange to a pool balance associated with the requested medium of exchange and transmit, to the second party, at least a portion of the request for payment in the cryptocurrency taken from the pool balance based on initiating the blockchain transaction.

The cryptocurrency manager 460 may receive an acknowledgement that the blockchain transaction is successful. The cryptocurrency manager 460 may transmit, to the second party, at least a portion of the request for payment in the cryptocurrency based on receiving the acknowledgement. The cryptocurrency manager 460 may receive a second cryptocurrency from the first party in response to transmitting the message, where initiating the blockchain transaction is based on receiving the second cryptocurrency. The cryptocurrency manager 460 may determine that the second cryptocurrency received from the first party is not included in the requested medium of exchange of the message, where initiating the blockchain transaction is based on determining that the second cryptocurrency received from the first party is not included in the requested medium of exchange of the message. The cryptocurrency manager 460 may encrypt data related to the blockchain transaction before initiating the blockchain transaction. The cryptocurrency manager 460 may transfer the cryptocurrency to the second party based on determining the requested medium of exchange includes the cryptocurrency.

The notification manager 465 may transmit a notification to the first party that the second party has received the cryptocurrency as part of the request for payment.

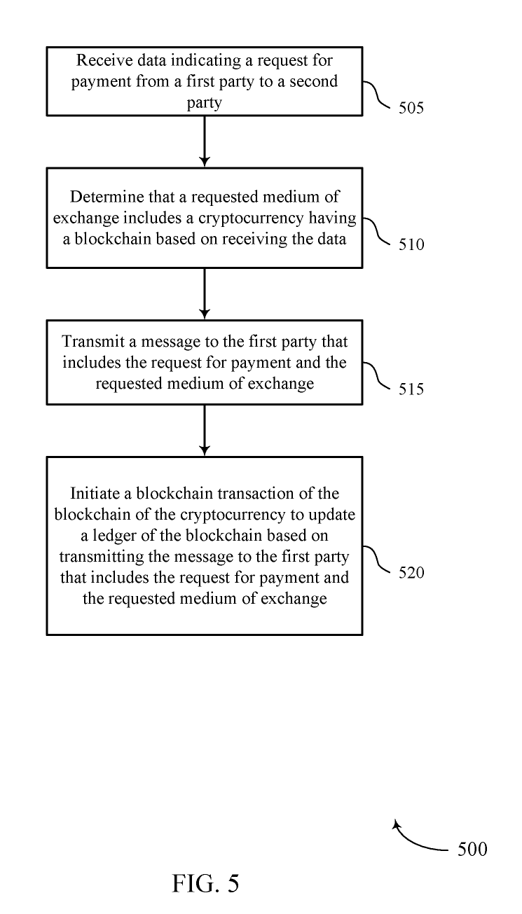

FIG. 5 shows a flowchart illustrating a method 500 for techniques for blockchain transactions in accordance with aspects of the present disclosure. The operations of method 500 may be implemented by a transaction component 115 or 400 or its components as described herein. For example, the operations of method 500 may be performed by a transaction component as described with reference to FIGS. 1-3. In some examples, a transaction component 115 may execute a set of codes to control the functional elements of the device to perform the functions described below. Additionally or alternatively, the transaction component 115 may perform aspects of the functions described below using special-purpose hardware.

At 505 the transaction component 115 may receive data indicating a request for payment from a first party to a second party. The operations of 505 may be performed according to the methods described herein. In certain examples, aspects of the operations of 505 may be performed by a job manager as described with reference to FIG. 4.

At 510 the transaction component 115 may determine that a requested medium of exchange includes a cryptocurrency having a blockchain based at least in part on receiving the data. The operations of 510 may be performed according to the methods described herein. In certain examples, aspects of the operations of 510 may be performed by an exchange manager as described with reference to FIG. 4.

At 515 the transaction component 115 may transmit a message to the first party that includes the request for payment and the requested medium of exchange. The operations of 515 may be performed according to the methods described herein. In certain examples, aspects of the operations of 515 may be performed by a communications manager as described with reference to FIG. 4.

At 520 the transaction component 115 may initiate a blockchain transaction of the blockchain of the cryptocurrency to update a ledger of the blockchain based at least in part on transmitting the message to the first party that includes the request for payment and the requested medium of exchange. The operations of 520 may be performed according to the methods described herein. In certain examples, aspects of the operations of 520 may be performed by a blockchain manager as described with reference to FIG. 4.

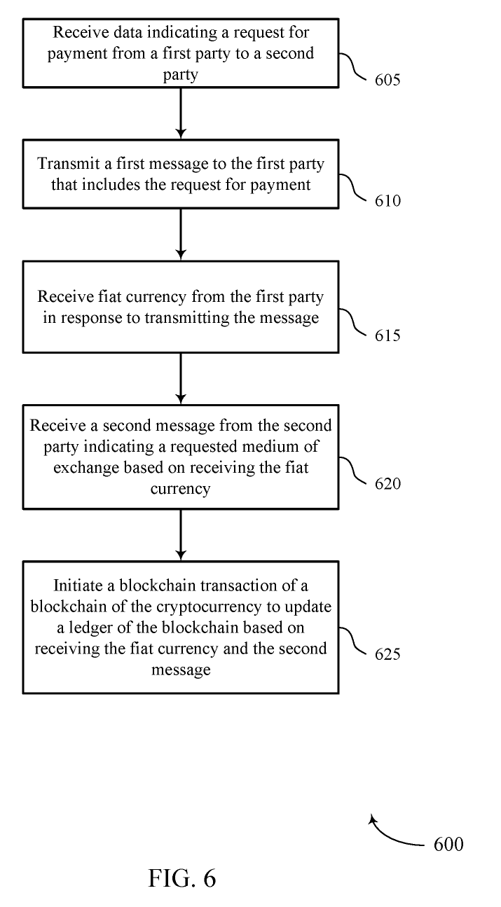

FIG. 6 shows a flowchart illustrating a method 600 for techniques for blockchain transactions in accordance with aspects of the present disclosure. The operations of method 600 may be implemented by a transaction component 115 or 400 or its components as described herein. For example, the operations of method 600 may be performed by a transaction component as described with reference to FIG. 4. In some examples, a transaction component 115 may execute a set of codes to control the functional elements of the device to perform the functions described below. Additionally or alternatively, the transaction component 115 may perform aspects of the functions described below using special-purpose hardware.

At 605 the transaction component 115 may receive data indicating a request for payment from a first party to a second party. The operations of 605 may be performed according to the methods described herein. In certain examples, aspects of the operations of 605 may be performed by a job manager as described with reference to FIG. 4.

At 610 the transaction component 115 may transmit a first message to the first party that includes the request for payment. The operations of 610 may be performed according to the methods described herein. In certain examples, aspects of the operations of 610 may be performed by a communications manager as described with reference to FIG. 4.

At 615 the transaction component 115 may receive fiat currency from the first party in response to transmitting the message. The operations of 615 may be performed according to the methods described herein. In certain examples, aspects of the operations of 615 may be performed by a fiat manager as described with reference to FIG. 4.

At 620 the transaction component 115 may receive a second message from the second party indicating a requested medium of exchange based at least in part on receiving the fiat currency. The operations of 620 may be performed according to the methods described herein. In certain examples, aspects of the operations of 620 may be performed by a communications manager as described with reference to FIG. 4.

At 625 the transaction component 115 may initiate a blockchain transaction of a blockchain of the cryptocurrency to update a ledger of the blockchain based at least in part on receiving the fiat currency and the second message. The operations of 625 may be performed according to the methods described herein. In certain examples, aspects of the operations of 625 may be performed by a blockchain manager as described with reference to FIG. 4.

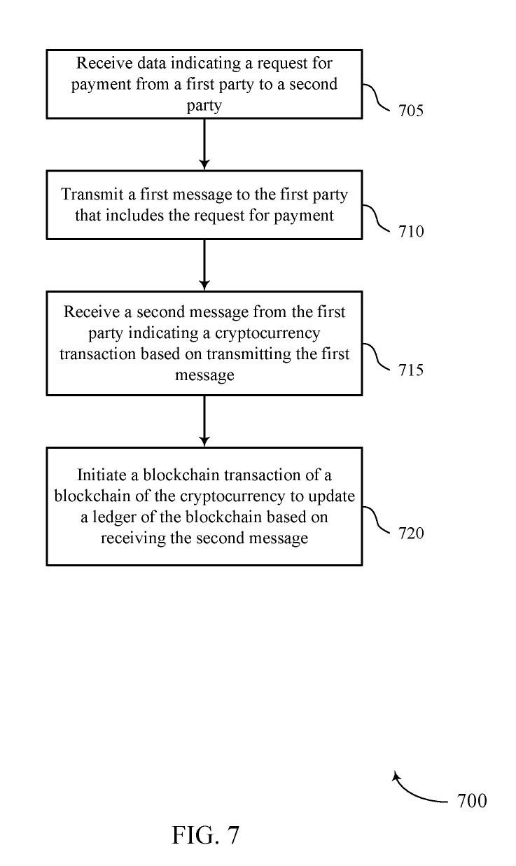

FIG. 7 shows a flowchart illustrating a method 700 for techniques for blockchain transactions in accordance with aspects of the present disclosure. The operations of method 700 may be implemented by a transaction component 115 or 400 or its components as described herein. For example, the operations of method 700 may be performed by a transaction component as described with reference to FIG. 4. In some examples, a transaction component 115 may execute a set of codes to control the functional elements of the device to perform the functions described below. Additionally or alternatively, the transaction component 115 may perform aspects of the functions described below using special-purpose hardware.

At 705 the transaction component 115 may receive data indicating a request for payment from a first party to a second party. The operations of 705 may be performed according to the methods described herein. In certain examples, aspects of the operations of 705 may be performed by a job manager as described with reference to FIG. 4.

At 710 the transaction component 115 may transmit a first message to the first party that includes the request for payment. The operations of 710 may be performed according to the methods described herein. In certain examples, aspects of the operations of 710 may be performed by a communications manager as described with reference to FIG. 4.

At 715 the transaction component 115 may receive a second message from the first party indicating a cryptocurrency transaction based at least in part on transmitting the first message. The operations of 715 may be performed according to the methods described herein. In certain examples, aspects of the operations of 715 may be performed by a communications manager as described with reference to FIG. 4.

At 720 the transaction component 115 may initiate a blockchain transaction of a blockchain of the cryptocurrency to update a ledger of the blockchain based at least in part on receiving the second message. The operations of 720 may be performed according to the methods described herein. In certain examples, aspects of the operations of 720 may be performed by a blockchain manager as described with reference to FIG. 4.

It should be noted that the methods described above describe possible implementations, and that the operations and the steps may be rearranged or otherwise modified and that other implementations are possible. Further, aspects from two or more of the methods may be combined.

The detailed description set forth above in connection with the appended drawings describes examples and does not represent the only instances that may be implemented or that are within the scope of the claims. The terms “example” and “exemplary,” when used in this description, mean “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and apparatuses are shown in block diagram form in order to avoid obscuring the concepts of the described examples.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and components described in connection with this disclosure may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, and/or state machine. A processor may also be implemented as a combination of computing devices, e.g., a combination of a DSP and a microprocessor, multiple microprocessors, one or more microprocessors in conjunction with a DSP core, and/or any other such configuration. An operating system utilized by the processor (or by I/O controller module or another module described above) may be iOS®, ANDROID®, MS-DOS®, MS-WINDOWS®, OS/2®, UNIX®, LINUX®, or another known operating system.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope and spirit of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations.

As used herein, including in the claims, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination. Also, as used herein, including in the claims, “or” as used in a list of items (for example, a list of items prefaced by a phrase such as “at least one of” or “one or more of”) indicates a disjunctive list such that, for example, a list of “at least one of A, B, or C” means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

In addition, any disclosure of components contained within other components or separate from other components should be considered exemplary because multiple other architectures may potentially be implemented to achieve the same functionality, including incorporating all, most, and/or some elements as part of one or more unitary structures and/or separate structures.

Computer-readable media includes both computer storage media and communication media including any medium that facilitates transfer of a computer program from one place to another. A storage medium may be any available medium that can be accessed by a general purpose or special purpose computer. By way of example, and not limitation, computer-readable media can comprise RAM, ROM, EEPROM, flash memory, CD-ROM, DVD, or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The previous description of the disclosure is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not to be limited to the examples and designs described herein but is to be accorded the broadest scope consistent with the principles and novel features disclosed.

The process parameters, actions, and steps described and/or illustrated in this disclosure are given by way of example only and can be varied as desired. For example, while the steps illustrated and/or described may be shown or discussed in a particular order, these steps do not necessarily need to be performed in the order illustrated or discussed. The various exemplary methods described and/or illustrated here may also omit one or more of the steps described or illustrated here or include additional steps in addition to those disclosed.

Furthermore, while various embodiments have been described and/or illustrated here in the context of fully functional computing systems, one or more of these exemplary embodiments may be distributed as a program product in a variety of devices, regardless of the particular type of computer-readable media used to actually carry out the distribution. The embodiments disclosed herein may also be implemented using software modules that perform certain tasks. These software modules may include script, batch, or other executable files that may be stored on a computer-readable storage medium or in a computing system. In some embodiments, these software modules may permit and/or instruct a computing system to perform one or more of the exemplary embodiments disclosed here.

This description, for purposes of explanation, has been described with reference to specific embodiments. The illustrative discussions above, however, are not intended to be exhaustive or limit the present systems and methods to the precise forms discussed. Many modifications and variations are possible in view of the above teachings. The embodiments were chosen and described in order to explain the principles of the present systems and methods and their practical applications, to enable others skilled in the art to utilize the present systems, apparatus, and methods and various embodiments with various modifications as may be suited to the particular use contemplated.

What is claimed is:

1. A method, comprising:
receiving data indicating a request for payment from a first party to a second party;
determining that a requested medium of exchange includes a cryptocurrency having a blockchain based at least in part on receiving the data;
transmitting a message to the first party that includes the request for payment and the requested medium of exchange; and
initiating a blockchain transaction of the blockchain of the cryptocurrency to update a ledger of the blockchain based at least in part on transmitting the message to the first party that includes the request for payment and the requested medium of exchange.

2. The method of claim 1, further comprising:
receiving fiat currency from the first party in response to transmitting the message, wherein initiating the blockchain transaction is based at least in part on receiving the fiat currency.

3. The method of claim 2, further comprising:
determining that the fiat currency received from the first party is not included in the requested medium of exchange of the message, wherein initiating the blockchain transaction is based at least in part on determining that the fiat currency received from the first party is not included in the requested medium of exchange of the message.

4. The method of claim 1, further comprising:
assigning a transaction identifier to the blockchain transaction before initiating the blockchain transaction.

5. The method of claim 4, further comprising:
identifying a user identifier associated with the cryptocurrency; and
generating combined identifier by combining the user identifier and the transaction identifier, wherein the blockchain transaction is initiated using the combined identifier.

6. The method of claim 1, further comprising:
identifying a plurality of exchanges associated with the cryptocurrency; and
selecting one exchange of the plurality of exchanges to initiate the blockchain transaction, wherein initiating the blockchain transaction is based at least in part on selecting the one exchange.

7. The method of claim 1, further comprising:
comparing the request for payment and the requested medium of exchange to a pool balance associated with the requested medium of exchange; and
transmitting, to the second party, at least a portion of the request for payment in the cryptocurrency taken from the pool balance based at least in part on initiating the blockchain transaction.

8. The method of claim 1, further comprising:
receiving an acknowledgement that the blockchain transaction is successful; and
transmitting, to the second party, at least a portion of the request for payment in the cryptocurrency based at least in part on receiving the acknowledgement.

9. The method of claim 1, further comprising:
transmitting a notification to the first party that the second party has received the cryptocurrency as part of the request for payment.

10. The method of claim 1, further comprising:
receiving a second cryptocurrency from the first party in response to transmitting the message, wherein initiating the blockchain transaction is based at least in part on receiving the second cryptocurrency.

11. The method of claim 10, further comprising:
determining that the second cryptocurrency received from the first party is not included in the requested medium of exchange of the message, wherein initiating the blockchain transaction is based at least in part on determining that the second cryptocurrency received from the first party is not included in the requested medium of exchange of the message.

12. The method of claim 11, further comprising:
initiating a second blockchain transaction for the second cryptocurrency to exchange the second cryptocurrency for the cryptocurrency included in the requested medium of exchange.

13. The method of claim 1, further comprising:
encrypting data related to the blockchain transaction before initiating the blockchain transaction.

14. A method, comprising:
receiving data indicating a request for payment from a first party to a second party;
transmitting a first message to the first party that includes the request for payment;
receiving fiat currency from the first party in response to transmitting the message;
receiving a second message from the second party indicating a requested medium of exchange based at least in part on receiving the fiat currency; and
initiating a blockchain transaction of a blockchain of the cryptocurrency to update a ledger of the blockchain based at least in part on receiving the fiat currency and the second message.

15. The method of claim 14, further comprising:
determining the requested medium of exchange based at least in part on receiving the second message, wherein initiating the blockchain transaction is based at least in part on determining the requested medium of exchange.

16. The method of claim 14, further comprising:
assigning a transaction identifier to the blockchain transaction before initiating the blockchain transaction.

17. A method, comprising:
receiving data indicating a request for payment from a first party to a second party;
transmitting a first message to the first party that includes the request for payment;
receiving a second message from the first party indicating a cryptocurrency transaction based at least in part on transmitting the first message; and
initiating a blockchain transaction of a blockchain of the cryptocurrency to update a ledger of the blockchain based at least in part on receiving the second message.

18. The method of claim 17, further comprising:
determining that a requested medium of exchange includes the cryptocurrency; and
transferring the cryptocurrency to the second party based at least in part on determining the requested medium of exchange includes the cryptocurrency.

19. The method of claim 17, further comprising:
determining that a requested medium of exchange includes a cryptocurrency having a second block different than the cryptocurrency and the blockchain;
initiating a second blockchain transaction of the second blockchain of the second cryptocurrency based at least in part on determining the requested medium of exchange includes the second cryptocurrency; and
initiating a third blockchain transaction of the blockchain of the cryptocurrency based at least in part on determining the requested medium of exchange includes the second cryptocurrency.

20. The method of claim 17, further comprising:
determining that a requested medium of exchange includes a fiat currency; and
initiating a second blockchain transaction of the blockchain of the cryptocurrency based at least in part on determining the requested medium of exchange includes the fiat currency.
